(19) United States
(12) Patent Application Publication
(10) Pub. No.: US 2025/0323584 A1
(43) Pub. Date: Oct. 16, 2025

(54) POLYMER GEL FOR TRIBOELECTRIC ENERGY HARVESTER INCLUDING PLASTICIZER AND TRIBOELECTRIC ENERGY HARVESTER INCLUDING THE SAME

(71) Applicant: KOREA UNIVERSITY OF TECHNOLOGY AND EDUCATION INDUSTRY-UNIVERSITY COOPERATION FOUNDATION, Cheonan-si, Chungcheongnam-do (KR)

(72) Inventors: Jin Woo BAE, Seoul (KR); Seung Ju OH, Cheonan-si, Chungcheongnam-do (KR); In Sun WOO, Cheongju-si, Chungcheongbuk-do (KR)

(73) Assignee: KOREA UNIVERSITY OF TECHNOLOGY AND EDUCATION INDUSTRY-UNIVERSITY COOPERATION FOUNDATION, Cheonan-si, Chungcheongnam-do (KR)

(21) Appl. No.: 18/868,774

(22) PCT Filed: Dec. 6, 2023
(86) PCT No.: PCT/KR2023/019956

§ 371 Date: Nov. 24, 2024

(30) Foreign Application Priority Data
Dec. 7, 2022 (KR) 10-2022-0170070

(51) Int. Cl. H02N 1/04; C08J 3/11; C08K 5/101; C08K 5/12

(52) U.S. Cl. CPC H02N 1/04; C08J 3/11; C08K 5/101; C08K 5/12; C08J 2327/06

(57) ABSTRACT

The present invention relates to a polymer gel for a triboelectric energy harvester and a triboelectric energy harvester including the same, and more particularly, the polymer gel includes a specific plasticizer, and the plasticizer is included in an appropriate amount, and accordingly, the triboelectric energy harvester containing the plasticizer exhibits excellent performance.

### TECHNICAL FIELD

The present disclosure relates to a polymer gel for a triboelectric energy harvester including a plasticizer, and a triboelectric energy harvester including the same, and more particularly, the polymer gel includes a specific plasticizer, and the plasticizer is included in an appropriate amount, and accordingly, the triboelectric energy harvester containing the plasticizer exhibits excellent performance.

The present invention has resulted from research supported by the program of ‘application of next-generation highly transparent and stretchable sensors and electrochemical display elements using non-aqueous-based high-performance multifunctional ionic and non-ionic conducting polymer gels’ (No. 1711190086) through the National Research Foundation of Korea (NRF), funded by the Ministry of Science and ICT from Mar. 1, 2021 to Feb. 29, 2024.

### BACKGROUND ART

Triboelectric nanogenerators (TENGs), which convert mechanical energy into electrical energy, have been actively researched and developed due to benefits therefrom such as high energy conversion efficiencies, low manufacturing costs, simple and flexible structures, and the possibility of being fabricated using a variety of materials. The performance of TENGs is greatly affected by the amount of charge generated through friction and the efficiency of the process of separating positive and negative charges.

In general, two approaches are employed to enhance the performance of TENGs. The first approach involves using appropriate frictional materials having distinctly different polarities to increase the amount of charge generated during the friction process, and the second approach involves forming a friction layer with a surface containing micro or nano structures, or surface-modifying a friction layer at the nanoscale.

Meanwhile, selecting the right polymer resins and plasticizers is key to improving the performance of TENGs, and extensive research is being conducted in this area.

In this regard, the inventors, while conducting research to improve the performance of TEMGs, discovered suitable types of polymeric resins and plasticizers and determined an appropriate amount of the plasticizer, and thus found that using this material as a charged polymer layer in a triboelectric energy harvester allows the triboelectric energy harvester to exhibit superior performance, leading to this invention.

Related to this, Korean Patent Publication No. 10-2021-0040342 discloses an energy harvester and a method for manufacturing the same.

### DISCLOSURE OF THE INVENTION

### Technical Goals

The present disclosure provides a polymer gel for a triboelectric energy harvester including a polymer resin and a plasticizer.

The present disclosure also provides a triboelectric energy harvester including the polymer gel.

### Technical Solutions

As a technical means to achieve the technical tasks described above, in accordance with an exemplary embodiment of the present invention,

a polymer gel for a triboelectric energy harvester includes a polymer resin and a plasticizer.

The polymer resin may include a polymer resin selected from the group consisting of polyvinyl chloride (PVC), polytetrafluoroethylene (PTFE), polyurethane (PU), polymethyl methacrylate (PMMA), polydimethylsiloxane (PDMS), polyvinyl alcohol (PVA), polyvinyl pyrrolidone (PVP), polyethylene oxide (PEO), polyimide (PI), polyethylene terephthalate (PET), and combinations thereof.

The plasticizer may include a plasticizer selected from the group consisting of a phthalate-based plasticizer, an ester-based plasticizer, and combinations thereof.

The phthalate-based plasticizer may include a plasticizer selected from the group consisting of butyl benzoate (BB), dibutyl phthalate (DBP), tributylbenzene-1,2,4-tricarboxylate (TBT), di-2-ethylhexyl phthalate (DOP), diheptyl phthalate (DHP), diisodecyl phthalate (DIDP), and combinations thereof.

The ester-based plasticizer may include a plasticizer selected from the group consisting of dibutyl adipate (DBA), ethylhexyl adipate (DOA), diisobutyl adipate (DIBA), adipic acid ester, adipic acid polyester, tri-2-ethylhexyl trimellitate (TOTM), triisononyl trimellitate (TINTM), and combinations thereof.

The plasticizer may be present in an amount of 100 to 500 parts by weight with respect to 100 parts by weight of the polymer resin.

The plasticizer may be present in an amount of 100 to 300 parts by weight with respect to 100 parts by weight of the polymer resin.

In accordance with another exemplary embodiment of the present invention,

a triboelectric energy harvester includes a first electrode and a second electrode, which are positioned spaced apart from each other, and a charged polymer layer including the polymer gel, bonded to one surface of the first electrode.

The first electrode may include a material selected from the group consisting of indium tin oxide (ITO), polyethylene terephthalate (PET), graphene, carbon nanotubes, and combinations thereof.

The second electrode may include a metal selected from the group consisting of aluminum (Al), copper (Cu), titanium (Ti), gold (Au), silver (Ag), platinum (Pt), nickel (Ni), zinc (Zn), iron (Fe), cobalt (Co), and combinations thereof.

The triboelectric energy harvester may further include a conductive layer bonded to one surface of the second electrode.

The conductive layer may include a material selected from the group consisting of nylon, cotton, silk, wool, polyester, polyvinyl alcohol (PVA), polyethylene (PE), polypropylene (PP), polyethylene terephthalate (PET), polytetrafluoroethylene (PTFE), polycarbonate (PC), polyarylate (PAR), ethylene vinyl acetate (EVA), polyimide (PI), and combinations thereof.

### Advantageous Effects

A polymer gel for a triboelectric energy harvester according to the present invention as described above includes a plasticizer in an appropriate amount, may thus have excellent dielectric constant and small leakage current values.

In addition, a triboelectric energy harvester including the polymer gel may have excellent output voltage and output current values.

### BRIEF DESCRIPTION OF DRAWINGS

FIG. 1 is a schematic view showing a method for manufacturing a triboelectric energy harvester according to an embodiment of the present invention;

FIGS. 2 to 4 are each graphs showing the dielectric constant of a polymer gel as a function of the type and amount of a plasticizer, according to an embodiment of the present invention;

FIGS. 5 to 7 are each graphs showing the leakage current of a polymer gel as a function of the type and amount of a plasticizer, according to an embodiment of the present invention;

FIG. 8 is a schematic view showing a triboelectric energy harvester according to an embodiment of the present invention; and

FIGS. 9 and 10 are each graphs showing the performance of a triboelectric energy harvester according to an embodiment of the present invention.

### MODE FOR CARRYING OUT THE INVENTION

Hereinafter, the present invention will be described in more detail. However, the present invention may be embodied in various different forms and is not limited by the embodiments described herein, and shall be defined only by the appended claims.

In addition, the terms used herein are only used to describe specific embodiments, and are not intended to limit the present invention. The singular forms are intended to include the plural forms as well, unless the context clearly indicates otherwise. Throughout the entire description of the present invention, when one part is said to ‘include (or comprise)’ an element, unless specifically mentioned otherwise, instead of excluding any other element, this may signify that the one part may further include other elements.

A first aspect herein provides

a polymer gel for a triboelectric energy harvester including a polymer resin and a plasticizer.

Hereinafter, the polymer gel for a triboelectric energy harvester according to the first aspect herein will be described in detail.

In an embodiment herein, the polymer gel for a triboelectric energy harvester may include a polymer resin. In this case, the polymer resin may be a non-aqueous polymer, and accordingly, the polymer gel for a triboelectric energy harvester may have long-term stability without changes in weight and volume.

In an embodiment herein, the polymer resin may be plasticized without a solvent, and may include a polymer resin selected from the group consisting of polyvinyl chloride (PVC), polytetrafluoroethylene (PTFE), polyurethane (PU), polymethyl methacrylate (PMMA), polydimethylsiloxane (PDMS), polyvinyl alcohol (PVA), polyvinyl pyrrolidone (PVP), polyethylene oxide (PEO), polyimide (PI), polyethylene terephthalate (PET), and combinations thereof, and may preferably include polyvinyl chloride (PVC).

In an embodiment herein, the plasticizer may be a material that plasticizes the polymer resin at a specific temperature and may have a flash point of 200° C. or greater. Meanwhile, the polymer resin and the plasticizer may be mixed using a solvent such as tetrahydrofuran (THF).

In an embodiment herein, the plasticizer may include a plasticizer selected from the group consisting of a phthalate-based plasticizer, an ester-based plasticizer, and combinations thereof.

In this case, the phthalate-based plasticizer may include a plasticizer selected from the group consisting of butyl benzoate (BB), dibutyl phthalate (DBP), tributylbenzene-1,2,4-tricarboxylate (TBT), di-2-ethylhexyl phthalate (DOP), diheptyl phthalate (DHP), diisodecyl phthalate (DIDP), and combinations thereof. Meanwhile, the plasticizer may be preferably a phthalate-based plasticizer, and may be more preferably, butyl benzoate (BB), dibutyl phthalate (DBP), or tributylbenzene-1,2,4-tricarboxylate (TBT), and even more preferably, butyl benzoate (BB).

Meanwhile, according to an embodiment of the present invention, the plasticizer may be butyl benzoate (BB), dibutyl phthalate (DBP), or tributylbenzene-1,2,4-tricarboxylate (TBT), and the butyl benzoate (BB), the dibutyl phthalate (DBP), or the tributylbenzene-1,2,4-tricarboxylate (TBT) may be represented by Formulas 1 to 3 below, respectively.

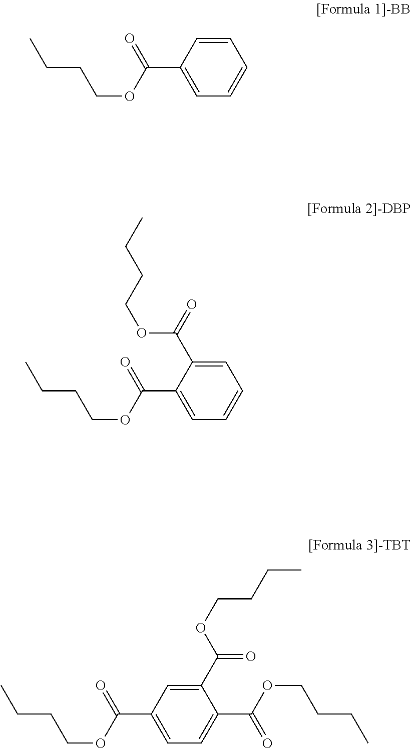 [SMILES: CCCCOC(=O)c1ccccc1 ; CCCCOC(=O)c1ccccc1C(=O)OCCCC ; CCCCOC(=O)c1ccc(C(=O)OCCCC)c(C(=O)OCCCC)c1]

That is, as shown in Formulas 1 to 3 above, BB, DBP, and TBT may have one, two, and three functional groups, respectively, centered around a benzene ring.

In an embodiment herein, the plasticizer may be present in an amount of 100 to 500 parts by weight with respect to 100 parts by weight of the polymer resin, and more preferably, 100 to 300 parts by weight with respect to 100 parts by weight of the polymer resin. When the plasticizer is present in an amount of less than 100 parts by weight with respect to 100 parts by weight of the polymer resin, the polymer gel for a triboelectric energy harvester may have a decrease in dielectric constant, and when the plasticizer is present in an amount of greater than 500 parts by weight, with an increase in leakage current values, the triboelectric energy harvester including the polymer gel may have a decrease in output voltage and output current, ultimately leading to a deterioration in the performance of the triboelectric energy harvester.

In an embodiment herein, the polymer gel for a triboelectric energy harvester includes a plasticizer in an appropriate amount, may thus have excellent dielectric constant and small leakage current values. Therefore, by applying the polymer gel to a charged polymer layer of the triboelectric energy harvester, the triboelectric energy harvester may exhibit excellent performance.

A second aspect herein provides

a triboelectric energy harvester including a first electrode and a second electrode, which are positioned spaced apart from each other, and a charged polymer layer including the polymer gel according to the first aspect, bonded to one surface of the first electrode.

Although detailed descriptions of portions that overlap the first aspect herein have been skipped, the descriptions of the first aspect herein may be equally applied to the second aspect, even if such descriptions are not stated in the second aspect.

Hereinafter, the triboelectric energy harvester according to the second aspect herein will be described in detail.

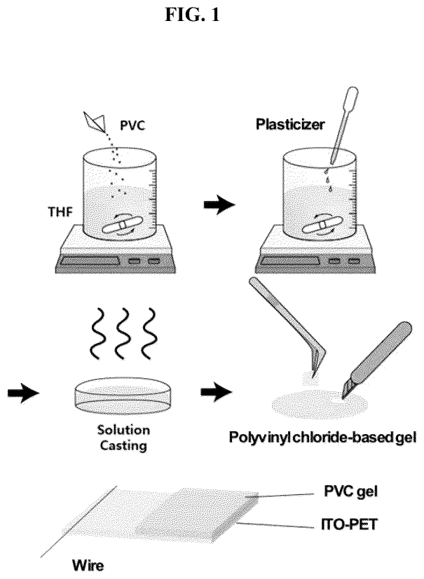

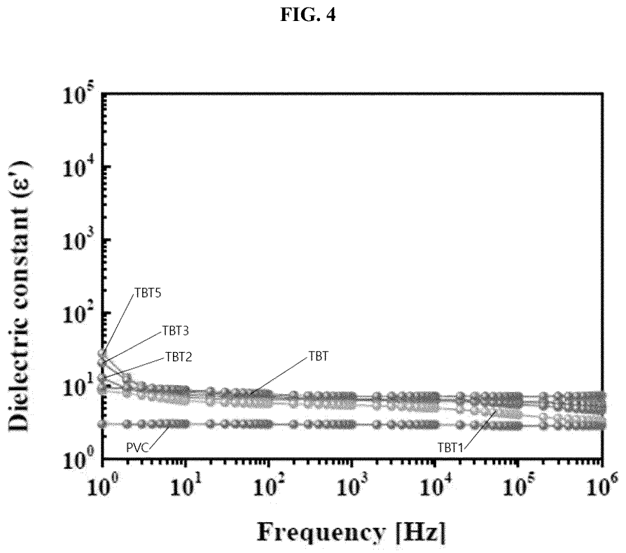

In an embodiment herein, the triboelectric energy harvester may include a first electrode and a second electrode, and as shown in FIGS. 1 and 4, a charged polymer layer including a polymer gel according to the first aspect herein may be bonded to one surface of the first electrode. In this case, the bonding may be used without limitation as long as it uses a typical bonding method.

In an embodiment herein, the first electrode may include a material selected from the group consisting of indium tin oxide (ITO), polyethylene terephthalate (PET), graphene, carbon nanotubes, and combinations thereof, and according to an embodiment of the present invention, an ITO-PET material may be used.

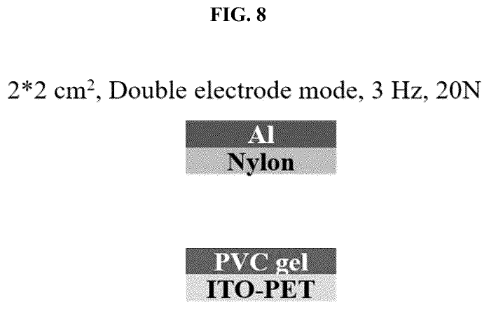

In an embodiment herein, as shown in FIG. 8, the second electrode may be positioned spaced apart from the first electrode. In this case, the second electrode may include a metal selected from the group consisting of aluminum (Al), copper (Cu), titanium (Ti), gold (Au), silver (Ag), platinum (Pt), nickel (Ni), zinc (Zn), iron (Fe), cobalt (Co), and combinations thereof, and according to an embodiment of the present invention, aluminum (Al) may be used.

In an embodiment herein, the triboelectric energy harvester may further include a conductive layer bonded to one surface of the second electrode. In this case, the conductive layer may include a material selected from the group consisting of nylon, cotton, silk, wool, polyester, polyvinyl alcohol (PVA), polyethylene (PE), polypropylene (PP), polyethylene terephthalate (PET), polytetrafluoroethylene (PTFE), polycarbonate (PC), polyarylate (PAR), ethylene vinyl acetate (EVA), polyimide (PI), and combinations thereof, and according to an embodiment of the present invention, nylon may be used.

In an embodiment herein, the triboelectric energy harvester may include a polymer gel bonded to one surface of the first electrode and a conductive layer bonded to the second electrode, and the polymer gel and the conductive layer may be positioned in a direction facing each other. That is, as shown in FIG. 8, the first electrode, the polymer gel, the conductive layer, and the second electrode may be positioned sequentially, the polymer gel and the conductive layer may be installed spaced apart from each other, and the first electrode and the second electrode may each be connected to a measuring device through a wire.

In an embodiment herein, the triboelectric energy harvester includes the polymer gel according to the first aspect herein as a charged polymer layer, and may thus have excellent output voltage and output current values.

Hereinafter, examples of the present invention will be described in detail in such a manner that it may easily be performed by a person skilled in the art to which the present invention pertains. The present invention may, however, be embodied in many different forms, and is not limited to Examples set forth herein.

### Example 1. Manufacturing of Triboelectric Energy Harvester (PVC:BB=1:1)

### 1. Preparation of PVC-Based Polymer Gel

As shown in FIG. 1, polyvinyl chloride (PVC) was added to 25 mL of tetrahydrofuran (THF) under stirring at 400 rpm with a magnetic bar and dissolved therein. Butyl benzoate (BB), a plasticizer, was added to the solution and sufficiently stirred for 12 hours. Thereafter, the solution was poured into a petri dish and sufficiently dried at room temperature for 48 hours to prepare a PVC-based polymer gel.

In this case, a weight mixing ratio of the PVC and the BB was 1:1.

### 2. Manufacturing of Triboelectric Energy Harvester

As shown in FIG. 1, the PVC-based polymer gel prepared in the section of 1 above was bonded to an ITO-PET electrode and connected with a wire.

Thereafter, as shown in FIG. 8, nylon was bonded to an Al electrode, and the ITO-PET and Al electrodes were connected to each other through a wire.

### Example 2. Manufacturing of Triboelectric Energy Harvester (PVC:BB=1:2)

A triboelectric energy harvester was manufactured using the same method as in the section of 1 from Example 1, except that the weight mixing ratio of PVC and BB was changed to 1:2.

### Example 3. Manufacturing of Triboelectric Energy Harvester (PVC:BB=1:3)

A triboelectric energy harvester was manufactured using the same method as in the section of 1 from Example 1, except that the weight mixing ratio of PVC and BB was changed to 1:3.

### Example 4. Manufacturing of Triboelectric Energy Harvester (PVC:BB=1:5)

A triboelectric energy harvester was manufactured using the same method as in the section of 1 from Example 1, except that the weight mixing ratio of PVC and BB was changed to 1:5.

### Example 5. Manufacturing of Triboelectric Energy Harvester (PVC:DBP=1:1)

A triboelectric energy harvester was manufactured using the same method as in the section of 1 from Example 1, except that dibutyl phthalate (DBP) was used instead of BB.

### Example 6. Manufacturing of Triboelectric Energy Harvester (PVC:DBP=1:2)

A triboelectric energy harvester was manufactured using the same method as in Example 5, except that the weight mixing ratio of PVC and DBP was changed to 1:2.

### Example 7. Manufacturing of Triboelectric Energy Harvester (PVC:DBP=1:3)

A triboelectric energy harvester was manufactured using the same method as in Example 5, except that the weight mixing ratio of PVC and DBP was changed to 1:3.

### Example 8. Manufacturing of Triboelectric Energy Harvester (PVC:DBP=1:5)

A triboelectric energy harvester was manufactured using the same method as in Example 5, except that the weight mixing ratio of PVC and DBP was changed to 1:5.

### Example 9. Manufacturing of Triboelectric Energy Harvester (PVC:TBT=1:1)

A triboelectric energy harvester was manufactured using the same method as in the section of 1 from Example 1, except that tributylbenzene-1,2,4-tricarboxylate (TBT) was used instead of BB.

### Example 10. Manufacturing of Triboelectric Energy Harvester (PVC:TBT=1:2)

A triboelectric energy harvester was manufactured using the same method as in Example 9, except that the weight mixing ratio of PVC and TBT was changed to 1:2.

### Example 11. Manufacturing of Triboelectric Energy Harvester (PVC:TBT=1:3)

A triboelectric energy harvester was manufactured using the same method as in Example 9, except that the weight mixing ratio of PVC and TBT was changed to 1:3.

### Example 12. Manufacturing of Triboelectric Energy Harvester (PVC:TBT=1:5)

A triboelectric energy harvester was manufactured using the same method as in Example 9, except that the weight mixing ratio of PVC and TBT was changed to 1:5.

### Experimental Example 1. Observation of Characteristics of PVC-Based Polymer Gels

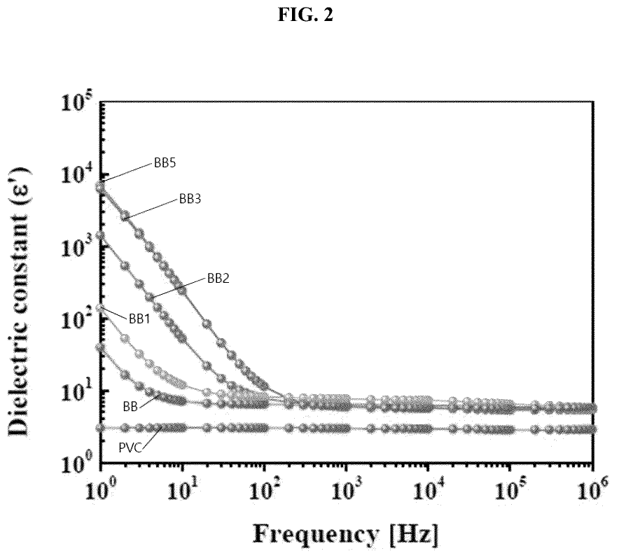

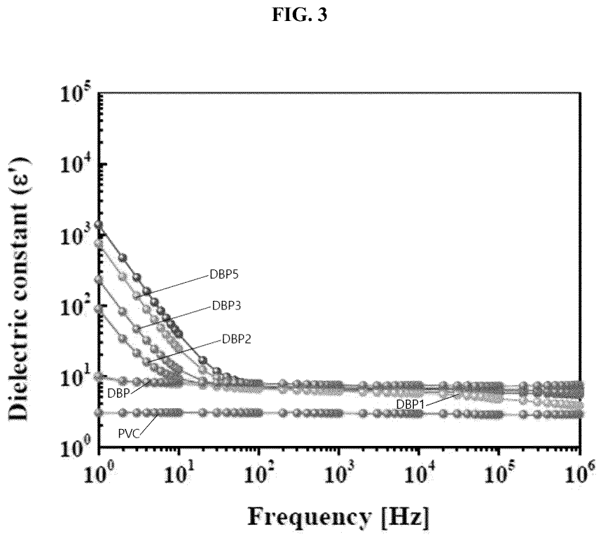

Dielectric constant values of the PVC-based polymer gels prepared in the section of 1 from Examples 1 to 4 were measured and the results thereof are shown in FIG. 2, dielectric constant values of the PVC-based polymer gels prepared in the section of 1 from Examples 5 to 8 were measured and the results thereof are shown in FIG. 3, and dielectric constant values of the PVC-based polymer gels prepared in the section of 1 from Examples 9 to 12 were measured and the results thereof are shown in FIG. 4.

As shown in FIGS. 2 to 4, it was determined that the dielectric constant values increased with the rising amount of the plasticizer, and that the dielectric constant value was highest in the order of BB, DBP, and TBT.

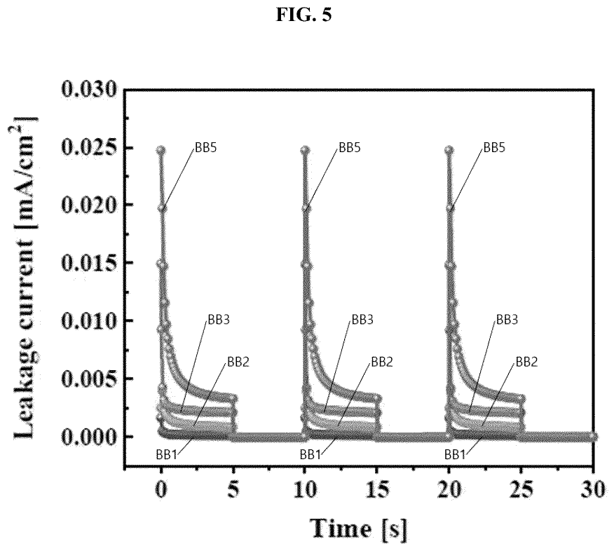

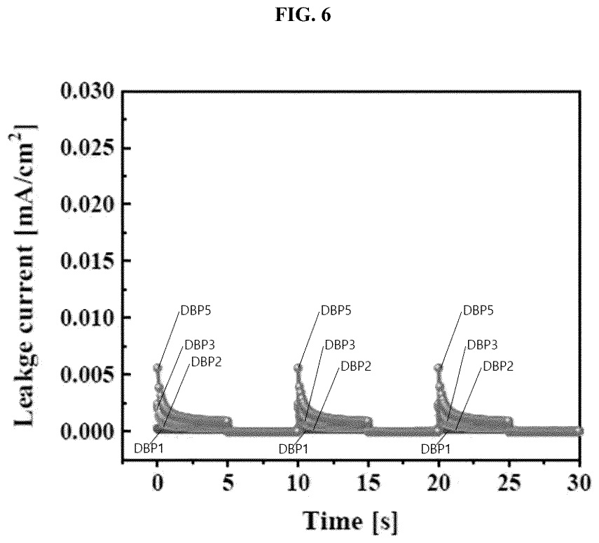

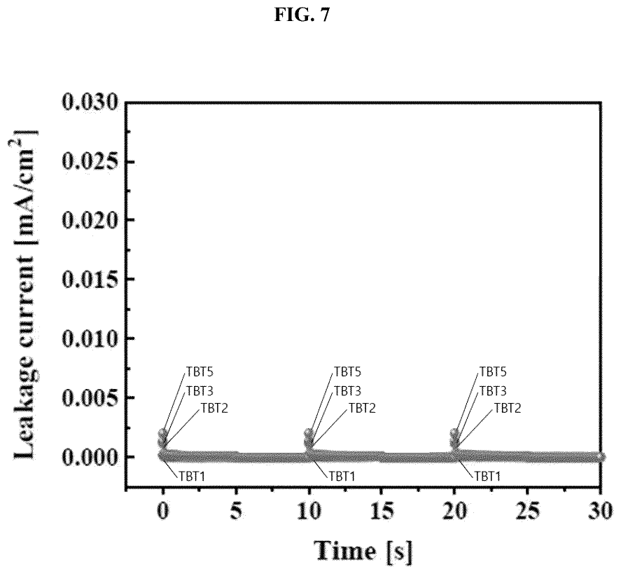

In addition, leakage current values of the PVC-based polymer gels prepared in the section of 1 from Examples 1 to 4 were measured and the results thereof are shown in FIG. 5, leakage current values of the PVC-based polymer gels prepared in the section of 1 from Examples 5 to 8 were measured and the results thereof are shown in FIG. 6, and leakage current values of the PVC-based polymer gels prepared in the section of 1 from Examples 9 to 12 were measured and the results thereof are shown in FIG. 7.

As shown in FIGS. 5 to 7, it was determined that the leakage current values increased with the rising amount of the plasticizer, and that the leakage current value was highest in the order of BB, DBP, and TBT.

Accordingly, it was determined that the dielectric constant value and the leakage current value were in a trade-off relationship.

### Experimental Example 2. Observation of Characteristics as Triboelectric Energy Harvester

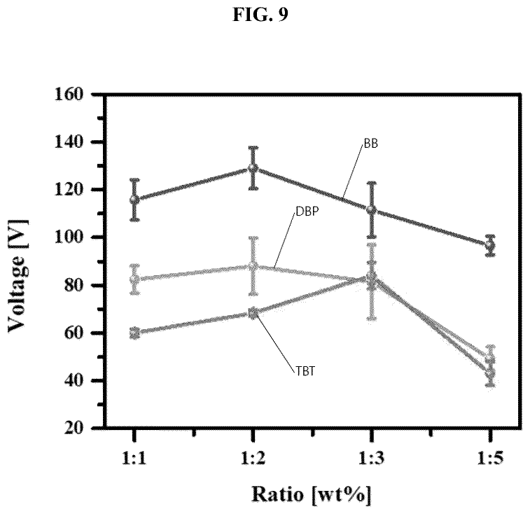

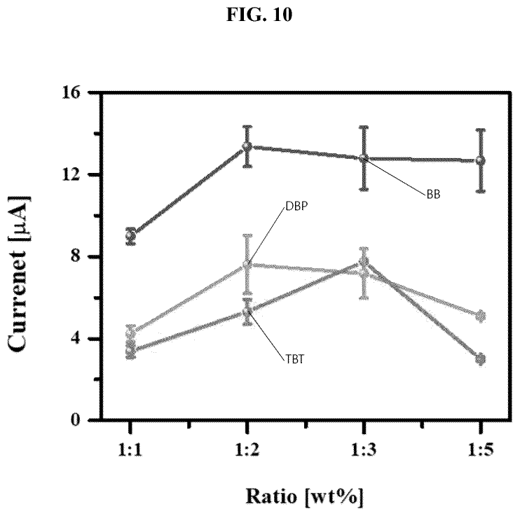

Output voltage and output current values of the triboelectric energy harvesters manufactured in Examples 1 to 12 were measured, and the results are shown in FIGS. 9 and 10.

Meanwhile, given that the performance of the triboelectric nanogenerator (TENG) was degraded when the weight ratio of PVC to plasticizer was 1:7, this ratio was considered unsuitable for this experiment and was therefore excluded.

As shown in FIGS. 9 and 10, it was determined that the triboelectric energy harvester using BB according to Examples 1 to 4 showed the best performance. It was analyzed that this was due to the high dielectric properties, and that the leakage current started to affect the system when the weight ratio of PVC and BB was greater than 1:3.

In addition, it was analyzed that the low output was due to the low negative characteristics and dielectric constant values when TBT was used.

The present invention has been described in detail with reference to the preferred embodiments and the drawings, but the scope of the technical idea of the present invention is not limited to these drawings and embodiments. Accordingly, various modifications or equivalents thereof may fall within the scope of the technical idea of the present invention. Therefore, the scope of the technical idea according to the present invention should be interpreted by the appended claims, and the technical idea within the scope identical or equivalent thereto should be construed as falling within the scope of the present invention.

1. A polymer gel for a triboelectric energy harvester comprising a polymer resin and a plasticizer.

2. The polymer gel for a triboelectric energy harvester of claim 1, wherein the polymer resin comprises a polymer resin selected from the group consisting of polyvinyl chloride (PVC), polytetrafluoroethylene (PTFE), polyurethane (PU), polymethyl methacrylate (PMMA), polydimethylsiloxane (PDMS), polyvinyl alcohol (PVA), polyvinyl pyrrolidone (PVP), polyethylene oxide (PEO), polyimide (PI), polyethylene terephthalate (PET), and combinations thereof.

3. The polymer gel for a triboelectric energy harvester of claim 1, wherein the plasticizer comprises a plasticizer selected from the group consisting of a phthalate-based plasticizer, an ester-based plasticizer, and combinations thereof.

4. The polymer gel for a triboelectric energy harvester of claim 3, wherein the phthalate-based plasticizer comprises a plasticizer selected from the group consisting of butyl benzoate (BB), dibutyl phthalate (DBP), tributylbenzene-1,2,4-tricarboxylate (TBT), di-2-ethylhexyl phthalate (DOP), diheptyl phthalate (DHP), diisodecyl phthalate (DIDP), and combinations thereof.

5. The polymer gel for a triboelectric energy harvester of claim 3, wherein the ester-based plasticizer comprises a plasticizer selected from the group consisting of dibutyl adipate (DBA), ethylhexyl adipate (DOA), diisobutyl adipate (DIBA), adipic acid ester, adipic acid polyester, tri-2-ethylhexyl trimellitate (TOTM), triisononyl trimellitate (TINTM), and combinations thereof.

6. The polymer gel for a triboelectric energy harvester of claim 1, wherein the plasticizer is present in an amount of 100 to 500 parts by weight with respect to 100 parts by weight of the polymer resin.

7. The polymer gel for a triboelectric energy harvester of claim 1, wherein the plasticizer is present in an amount of 100 to 300 parts by weight with respect to 100 parts by weight of the polymer resin.

8. A triboelectric energy harvester comprising:
a first electrode and a second electrode, which are positioned spaced apart from each other; and
a charged polymer layer comprising the polymer gel according to claim 1, bonded to one surface of the first electrode.

9. The triboelectric energy harvester of claim 8, wherein the first electrode comprises a material selected from the group consisting of indium tin oxide (ITO), polyethylene terephthalate (PET), graphene, carbon nanotubes, and combinations thereof.

10. The triboelectric energy harvester of claim 8, wherein the second electrode comprises a metal selected from the group consisting of aluminum (Al), copper (Cu), titanium (Ti), gold (Au), silver (Ag), platinum (Pt), nickel (Ni), zinc (Zn), iron (Fe), cobalt (Co), and combinations thereof.

11. The triboelectric energy harvester of claim 8, further comprising a conductive layer bonded to one surface of the second electrode.

12. The triboelectric energy harvester of claim 11, wherein the conductive layer comprises a material selected from the group consisting of nylon, cotton, silk, wool, polyester, polyvinyl alcohol (PVA), polyethylene (PE), polypropylene (PP), polyethylene terephthalate (PET), polytetrafluoroethylene (PTFE), polycarbonate (PC), polyarylate (PAR), ethylene vinyl acetate (EVA), polyimide (PI), and combinations thereof.
